(19) United States
(12) Patent Application Publication
(10) Pub. No.: US 2004/0153532 A1
(43) Pub. Date: Aug. 5, 2004

(54) Network device configuring method, network device configuring system and program for configuring network device

(75) Inventors: Kazuhiro Hosotani, Hyogo (JP); Takaji Fujiwara, Hyogo (JP)

Correspondence Address: OLIFF & BERRIDGE, PLC, P.O. BOX 19928, ALEXANDRIA, VA, 22320, US

(73) Assignee: FUJI XEROX CO.,LTD., TOKYO (JP)

(21) Appl. No.: 10/693,921

(22) Filed: Oct. 28, 2003

(30) Foreign Application Priority Data
Oct. 30, 2002 (JP) P2002-316796

(51) Int. Cl. G06F 15/177; G06F 3/00

(52) U.S. Cl. 709/222; 710/8

(57) ABSTRACT

An information processing apparatus acquires both model information of a first device and identification information specific to the first device from the first device, and acquires configuration information of the first device. Then, the information processing apparatus stores the acquired configuration information in a status correlated with the model information and the identification information. On the other hand, in such a case that both the model information and the identification information are transmitted from a second device, the information processing apparatus determines whether the stored model information is made coincident with the transmitted model information. When the transmitted model information is made coincident with the stored model information, the information processing apparatus transmits the stored configuration information to the second device. The second device receives the configuration information and configures in accordance with the transmitted configuration information.

### BACKGROUND OF THE INVENTION

1. Field of the Invention

The present invention generally relates to a network device configuring method, a network device configuring system, an information processing apparatus employed in the device configuring system, and a computer program capable of functioning a computer as the information processing apparatus for configuring various models of devices to be set, while the information processing apparatus and a plurality of models of devices are connected to each other via a communication network. More specifically, the present invention is directed to a device configuring method for configuring a batch of devices such as a plurality of models of devices installed in an office in a comprehensive manner.

2. Description of the Related Art

While a large number of electronic devices such as printers are installed in offices of enterprises, when these devices are used, configuring conditions of these devices are changed from the standard configuring conditions thereof so as to be customized in accordance with the respective enterprises. For example, in a case that printers are used as the devices, configuration for connecting each of the devices to LAN (Local Area Network) is to be needed. Also, printing emulation is set for each of the devices, and both a paper supply port and a paper eject port are set for each of the devices.

An example of conventional technique for configuring a plurality of conditions for a printer is disclosed in JP-A-4-078923.

However, while configuring items of devices which should be configured are increased year by year, if such a configuring operation is carried out for every device, then there is a risk that erroneous configuring operation may occur. Also, devices conducted to enterprises may be different in models, and furthermore, even when the same models of devices are installed, there are some cases that versions of these models are different from each other. Therefore, heavy workloads are necessarily required in order that while such a difference in models is recognized, different configuring operations are carried out for every device.

### SUMMARY OF THE INVENTION

The present invention has been made to solve the problems, and therefore, has an object to provide a device configuring method, a device configuring system, an information processing apparatus used in the device configuring system, and a software program product capable of causing a computer to function as an information processing apparatus for configuring a plurality of models of devices. That is, while model information as to a plurality of models of devices, identification information specific to the devices, and configuration information as to the plurality of models of devices are acquired by the information processing apparatus, in a case where an acquisition request for configuration information is issued from another device, since configuration information corresponding to the model information is transmitted so as to set the respective devices, the device configuring method and the device configuring system, according to the present invention, can set the plural sorts of devices in either a correct manner or a batch manner.

Another object of the present invention is to provide a device configuring system capable of configuring conditions of a large number of devices in a comprehensive manner, since completion information for indicating as to whether or not configuring operation has been completed is stored in each of the devices.

A further object of the present invention is to provide such a device configuring system capable of editing configuring operations of the respective devices in a comprehensive manner, since the configuring operations of the respective devices can be edited in an information processing apparatus, and also capable of reflecting an edited result also to other devices.

In order to achieve the objects, according to a first aspect of the invention, there is provided a device configuring method for configuring a plurality of devices of various kinds by an information processing apparatus in which connected to the devices via a communication network, the method including: acquiring from a first device both model information of the first device and identification information specific to the first device by the information processing apparatus; acquiring from the first device configuration information of the first device by the information processing apparatus; storing the acquired configuration information in a status correlated with both the model information and the identification information of the first device; acquiring from a second device both model information of the second device and identification information specific to the second device by the information processing apparatus; determining whether or not the model information of the first device and the model information of the second device coincide with each other; transmitting, when determined that the model information of the first device and the model information of the second device coincide with each other, the stored configuration information of the first device from the information processing apparatus to the second device; and configuring the second device in accordance with the transmitted configuration information.

According to a second aspect of the invention, there is provided a device configuring system including: a plurality of devices of various kinds; and an information processing apparatus in which connected to the devices via a communication network, wherein the information processing apparatus includes: a first acquiring unit configured to acquire from a first device both model information of the first device and identification information specific to the first device; a configuration information acquiring unit configured to acquire from the first device configuration information of the first device; a storing unit configured to store the acquired configuration information in a status correlated with both the model information and the identification information of the first device; a second acquiring unit configured to acquire from a second device both model information of the second device and identification information specific to the second device; a determining unit configured to determine whether or not the model information of the first device and the model information of the second device coincide with each other; and a transmitting unit configured to transmit, when determined that the model information of the first device and the model information of the second device coincide with each other, the stored configuration information of the first device to the second device, wherein the second device includes a configuring unit configured to perform a configuration thereof in accordance with the transmitted configuration information.

According to a third aspect of the invention, there is provided a device configuring system including: a plurality of devices of various kinds; and an information processing apparatus in which connected to the devices via a communication network, wherein the information processing apparatus includes: a first acquiring unit configured to acquire from a first device model information of the first device; a configuration information acquiring unit configured to acquire from the first device configuration information of the first device; a storing unit configured to store the acquired configuration information in a status correlated with the model information of the first device; and a transmitting unit configured to transmit the stored configuration information of the first device together with the correlated model information to a second device, wherein the second device includes: a determining unit configured to determine whether or not the transmitted model information of the first device coincides with a previously stored model information thereof; and a configuring unit configured to perform a configuration thereof in accordance with the transmitted configuration information in a case where determined that the transmitted model information and the previously stored model information coincide each other.

According to a fourth aspect of the invention, there is provided an information processing apparatus for configuring a plurality of devices of various kinds that are connected thereto via a communication network, the apparatus including: a first acquiring unit configured to acquire from a first device both model information of the first device and identification information specific to the first device; a configuration information acquiring unit configured to acquire from the first device configuration information of the first device; a storing unit configured to store the acquired configuration information in a status correlated with both the model information and the identification information of the first device; a second acquiring unit configured to acquire from a second device both model information of the second device and identification information specific to the second device; a determining unit configured to determine whether or not the model information of the first device and the model information of the second device coincide with each other; and a transmitting unit configured to transmit, when determined that the model information of the first device and the model information of the second device coincide with each other, the stored configuration information of the first device to the second device.

According to a fifth aspect of the invention, there is provided a software program product for causing a computer system to execute procedures for configuring a plurality of devices of various kinds that are connected thereto via a communication network, the software program product including: means for acquiring, from a first device, model information of the first device, identification information specific to the first device, and configuration information of the first device; means for storing the acquired configuration information in a status correlated with both the model information and the identification information of the first device; means for acquiring from a second device both model information of the second device and identification information specific to the second device; means for determining whether or not the model information of the first device and the model information of the second device coincide with each other; and means for transmitting, when determined that the model information of the first device and the model information of the second device coincide with each other, the stored configuration information of the first device to the second device.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a schematic diagram for indicating an outline of a device configuring system according to a first embodiment of the present invention;

FIG. 2 is a block diagram for representing hardware structures of a computer and of a printer;

FIG. 3 is a flow chart for explaining a process operation executed when an initial configuring operation of the printer is carried out;

FIG. 4 is an explanatory diagram for explaining a screen image used to perform a configuring operation;

FIG. 5 is an explanatory diagram for indicating a data structure of data which is transmitted from the printer to the computer;

FIG. 6 is a flow chart for indicating a sequential configuring operation of another printer after an initial configuring operation has been carried out;

FIG. 7 is a flow chart for indicating another sequential configuring operation of another printer after an initial configuring operation has been carried out;

FIG. 8 is a flow chart for indicating a sequential configuring operation of another printer after an initial configuring operation has been carried out, according to a second embodiment of the present invention;

FIG. 9 is an explanatory diagram for explaining an image of an edit menu;

FIG. 10 is a flow chart for describing a sequential operation of an editing process operation;

FIG. 11 is a flow chart for describing a sequential operation of an editing process operation; and

FIG. 12 is a block diagram for representing an arrangement of a computer according to a fourth embodiment of the invention.

### DETAILED DESCRIPTION OF THE PREFERRED EMBODIMENTS

Referring now to the accompanying drawings, a description will be given in detail of preferred embodiments of the invention.

### FIRST EMBODIMENT

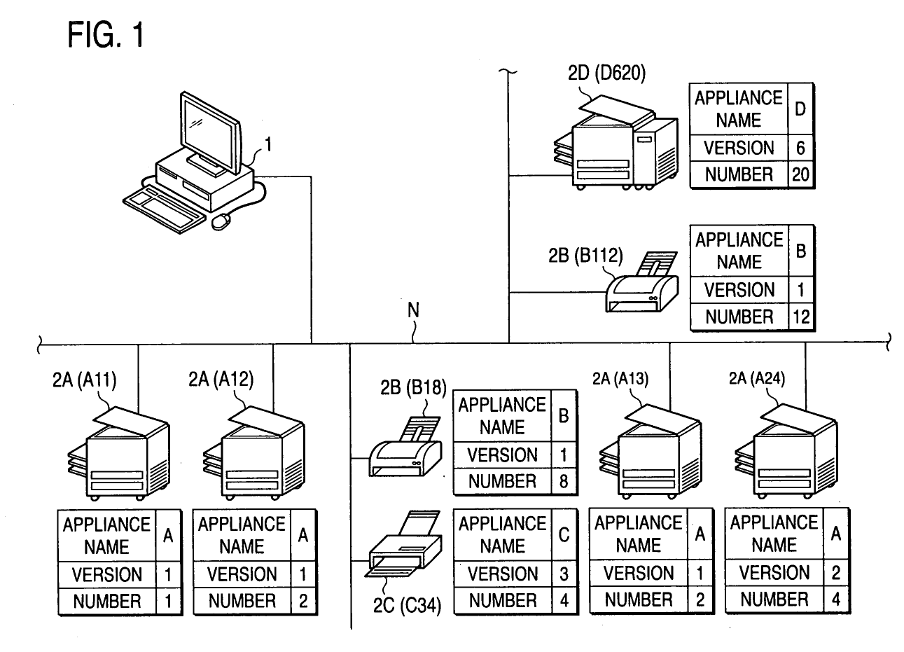

FIG. 1 is a schematic diagram showing an outline of a device configuring system according to a first embodiment of the present invention. Although the first embodiment explains that devices which should be set correspond to printers, the present invention is not limited thereto, but such appliances as refrigerators and vending machines may be employed. Also, apparently, the printers having printer functions may be replaced by composite type printers equipped with FAX (facsimile) functions and document copying functions.

The device configuring system according to the embodiment is arranged by an information processing apparatus 1 (will be referred to as “computer” hereinafter) and a plurality of models of printers 2A, 2B, 2C, and 2D (will be typically referred to as a “printer 2” hereinafter). The computer 1 and the respective printers 2 are connected to each other via a communication network “N” such as a LAN (Local Area Network) and the Internet. To the respective printers 2A, 2B, 2C, 2D, model names (such as A, B, and C) indicative of names of the printers 2 are applied; and versions (such as 1, 2, and 3) indicative of revision information of the printers 2 are applied; and also, serial numbers (such as 1, 2, and 3) corresponding to numbers within the communication network N are applied.

The device configuring system of the first embodiment will now be summarized. In a case where the printer 2 is set, firstly, a configuring operation as to a single set of printer 2 is carried. The configuring operation may be carried out in the computer 1, and in addition, the configuring operation may be carried out in the printer 2. Such a configuring case is now assumed in which a configuring operation is carried out as to such a condition that, for example, the model name of the printer 2 is “A” and the version thereof is “1.” In this case, a configuring operation as to one set of printer 2A (A11) is firstly carried out. After the configuring operation, the model name (A) and the version (1) , which correspond to the model information, and also, the identification information such as either a MAC address (Media Access Control address) or an IP address (Internet Protocol address) are transmitted to the computer 1 in combination with the configuration information. It should be noted that identification information specific to a printer 2 will be explained as being equal to a MAC address.

Next, when a power supply of another printer 2 is turned ON, both a MAC address corresponding to the identification information and model information (machine name and version) are transmitted to the computer 1. The computer 1 determines whether or not the transmitted model information is made coincident with the stored model information. For instance, in a case where the power supply of the printer 2A (A12) is turned ON, since both the machine name and the version of this printer 2A (A12) are identical to those of the above-explained printer 2A (A11), the same configuring operation may be carried out. In the above case, the configuration information that has been stored in the printer 2A (A11) is transmitted to the printer 2A (A12).

The configuring operation is similarly applied to another printer 2A (A13) equipped with the same model information. Therefore, both the printer 2A (A12) and the printer 2A (A13) perform configuring operations in accordance with the transmitted configuration information, and after the configuring operations are completed, these printers 2A (A12) and 2A (A13) transmit completion information to the computer 1. The completion information indicates that the configuring operations have been accomplished. On the other hand, in such a case that the transmitted model information is not made coincident with the stored model information (for instance, either versions or model names of printer 2A (A24) and printer 2B (B18) are different to each other), the computer 1 ceases to transmit the configuration information of the printer 2A (A11).

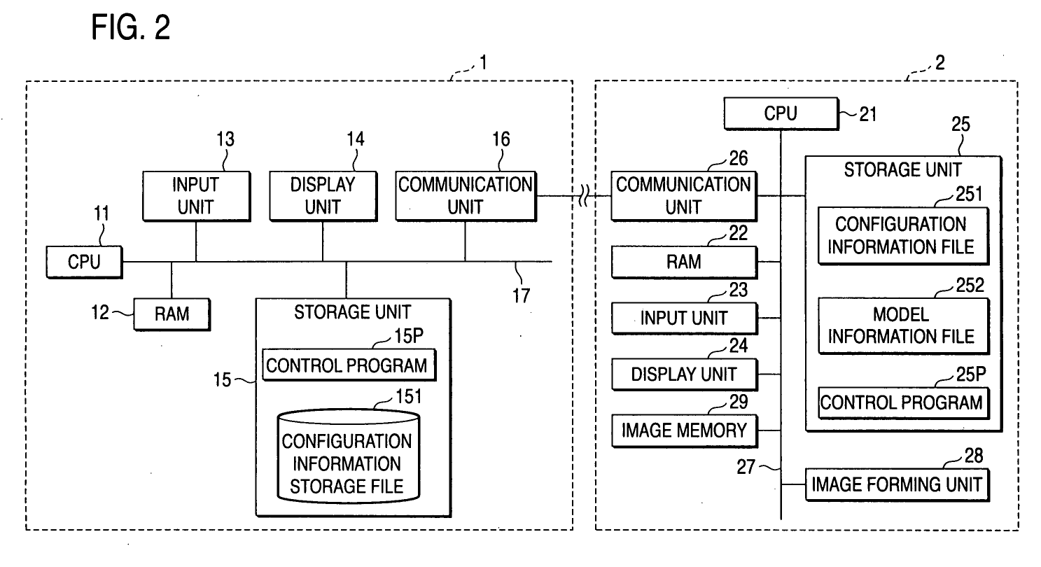

FIG. 2 is a block diagram for indicating a hardware construction of the computer 1 and a hardware construction of the printer 2. First, a description is made of the hardware construction of the computer 1. As indicated in this drawing, a RAM 12, a storage unit 15 such as a hard disk drive, a communication unit 16, a display unit 14 such as a liquid crystal display, and an input unit 13 such as a keyboard and a mouse are connected via a bus 17 to a CPU (Central Processing Unit) 11. The communication unit 16 corresponds to a gateway and a LAN card, and is used to transmit/receive information with respect to the printer 2. While the CPU 11 is connected via the bus 17 to the above-explained respective hardware units of the computer is 1, the CPU 11 controls these hardware units, and executes various software functions in accordance with a control program 15P which has been stored in a ROM 15.

The storage unit 15 is equipped with configuration information storage file which stores thereinto configuration information transmitted from the printer 2 in a status correlated with both a MAC address and model information.

Subsequently, a description will now be made of a hardware construction of the printer 2. A communication unit 26 such as either a LAN and or a USB interface, a RAM 22, and the like are connected via a bus 27 to the CPU 21 of the printer 2. Print data such as either characters or images, which is outputted from the computer 1 via the communication unit 26, is stored into an image memory 29. Thereafter, the print data is read out from the image memory 29 at predetermined timing, and then, is outputted to an image forming unit 28. The image forming unit 28 is equipped with a laser irradiating unit (not shown), a photosensitive drum (not shown), and the like, and performs an image forming operation. Then, an image forming process operation corresponding to the print data is carried out with respect to a recording paper (not shown).

The storage unit 25 stores thereinto such a software used to control either the RAM 22 or the image forming unit 28. When an image forming operation is carried out, the image forming process operation is carried out in accordance with the control program 25P related to the software stored in this storage unit 25. Also, configuration information file 251 is stored in the storage unit 25, and this configuration information file 251 is used to store thereinto configuration information of the printer 2 such as a paper supply port, a paper eject port, and an emulation. While an operator views the display unit 24 such as a liquid crystal display, the operator can edit the configuration information from an input unit 23 such as an operation panel. Also, the operator can similarly download configuration information of another printer 2 from the computer 1. Furthermore, the operator can also edit the configuration information from the input unit 13 of the computer 1. In a case where an image forming operation is carried out, the CPU 21 of the printer 2 reads out configuration information which has been stored in the configuration information file 251, and then, performs the image forming operation in accordance with this configuration information. A model information file 252 is further stored in the storage unit 25, while model information of the printer 2 has been stored in the model information file 252, and the model information corresponds to a vender name, an model name, a version, a serial number, and the like. The model information is written into the storage unit 25 when the product is manufactured. In the first embodiment, both the communication unit 16 of the computer 1 and the communication unit 26 of the printer 2 employ LAN cards, while MAC addresses specific to the respect LAN cards are applied. Both the computer 1 and the printer 2 acquire (recognize) the respective MAC addresses, and mutually recognize either the computer 1 or the printer 2, which are connected thereto.

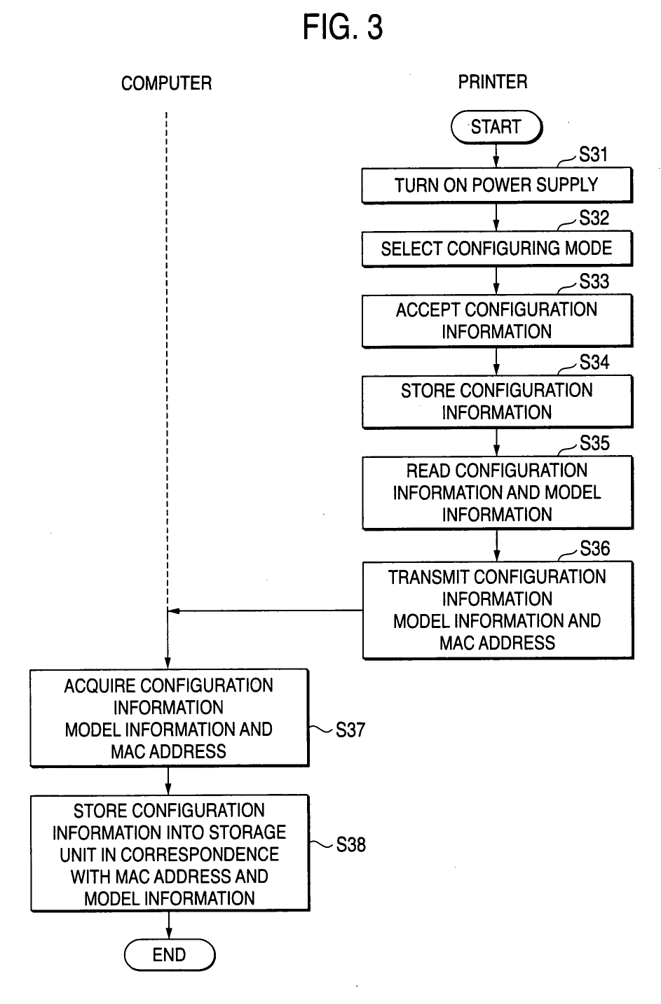

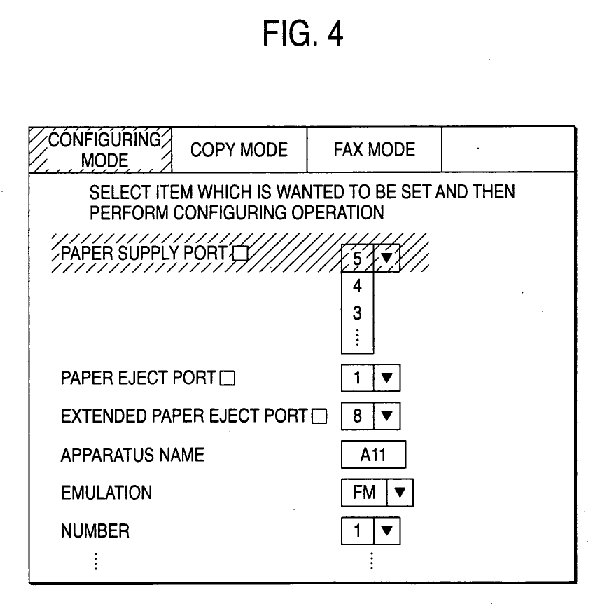

In the device configuring system with employment of the above-described structural units, the configuring process operation, according to the present invention, will now be described with reference to a flow chart. FIG. 3 is a flow chart for explaining an initial configuring operation of the printer 2. FIG. 4 is an explanatory diagram for indicating a display screen image used in the configuring operation. First, a description is made of a sequential process operation when an initial configuring operation as to the printer 2A (A11), the printer 2A (A12), and the printer 2A (A13), namely the printer 2A having the model name “A” and the version “1” is carried out. In the case above, as to one set of the printer 2, the operator manually enters configuration information. First, the operator connects the printer 2A (A11) to the computer 1, and thereafter, turns ON the power supply of this printer 2A (A11) in a step S31.

After the power supply of the printer 2A (A11) has been turned ON, the CPU 21 of the printer 2 executes the control program 25P, and displays a menu on the display unit 24. As indicated in FIG. 4, as a menu, a configuring mode, a copy mode, a FAX mode, and the like are displayed in a selectable manner. Then, the operator manipulates the input unit 23 so as to select the configuring mode (step S32). The operator manipulates the input unit 23 in order to select, or inputs both an item which is wanted to be set, and a configuring value. As a configuring subject, a configuring condition related to an environment where the printer 2 is used is selected. For example, a paper supply port, a paper eject port, and an emulation mode are set in the configuration. Also, in a case where the appliance corresponds to a cold reserving storage, configuring of a temperature condition and the like constitutes the configuring subject. In a case where the configuration information containing the item and the configuring value is entered, or selected, the CPU 21 accepts this configuration information (step S33), and stores the accepted configuration information into the RAM 22. The CPU 21 stores the configuration information stored in the RAM 22 into the configuration information file 251 (step S34).

Subsequently, the CPU 21 reads out the configuration information from the configuration information file 251, and reads out the model information from the machine sort file 252 (step S35). The CPU 21 of the printer 2 adds the MAC address (corresponding to identification information) to a header of a data packet of both the read configuration information and the read model information, and after a communication between this CPU 21 of the printer 2 and the computer 1 has been established, this CPU 21 transmits the data packet together with the MAC address (step S36).

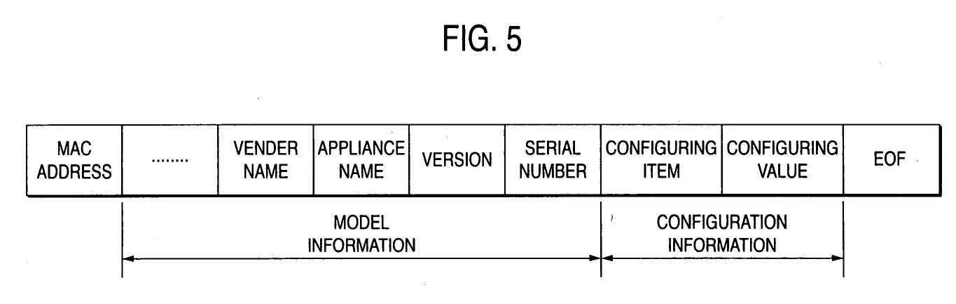

FIG. 5 is an explanatory diagram for explaining a data structure of data which is transmitted from the printer 2 to the computer 1. The data to be transmitted is classified into a MAC address (identification information) model information, and configuration information, which are employed so as to specify the printer 2. The model information contains such a model information indicative of an model name and version information. In this embodiment, in the case that a subject corresponds to the printer 2A (A211) , the model name is “A”, and the version is “1.” It should also be noted that the MAC address of the computer 1 is also added as the information of the transmission source. Further, symbol “EOF” indicates such information indicative of an end of the data which is transmitted.

As other information, a vender name, a serial number, and the like are contained in the model information. The configuration information contains such information as to both a configuring item and a configuring value, namely, contains the respective configuring values with respect to the configuring items shown in FIG. 4.

The computer 1 acquires the MAC address, the model information, and the configuration information, which are shown in FIG. 5 and have been transmitted, namely receives the transmitted data (step S37). The CPU 11 stores the configuration information into the configuration information storage file 151 in a status correlated with both the acquired model information and the acquired MAC address (step S38). In the embodiment, the operator performs the initial configuring operation via the input unit 23 of the printer 2, however, the present invention is not limited thereto. For example, while the operator may alternatively perform the initial configuring operation from the input unit 13 of the computer 1, both the model information and the configuration information which have been set may be transmitted to the printer 2 so as to execute the configuring operation. Also, the transmitted configuration information is stored in the configuration information storage file 151 provided in the storage unit 15 of the computer 1. Alternatively, the transmitted configuration information may be stored in a storage apparatus other than the computer 1, for example, in a database server (not shown).

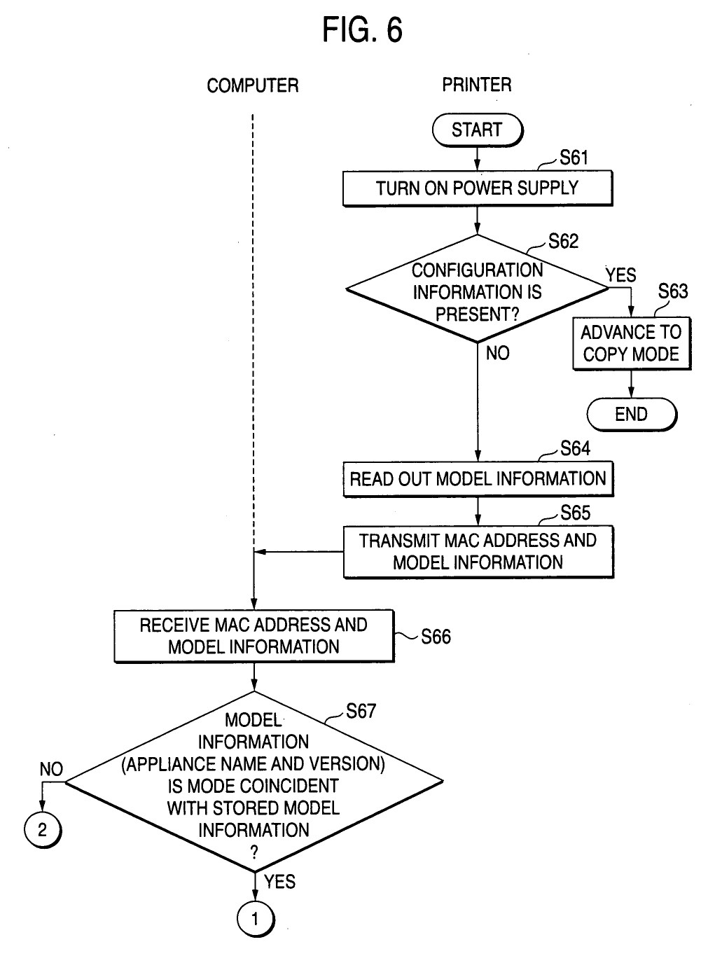

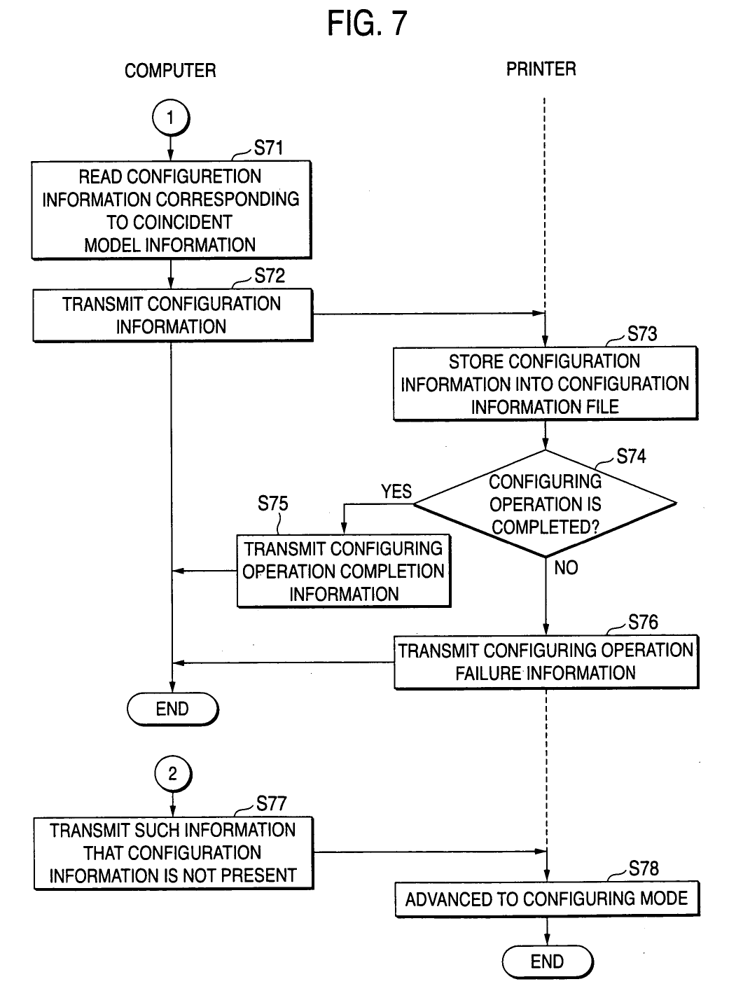

FIG. 6 and FIG. 7 are flow charts for explaining configuring sequential operations of another printer 2 after the initial configuring operation has been carried out. First, when the power supply of this printer 2 is turned ON by the operator (step S61), the CPU 21 initiates the control program 25P, and then, determines whether or not configuration information is present in the configuration information file 251 (step S62). In such a case that the configuration information is present (“YES” in step S62), since the initial configuring operation has been accomplished, the CPU 21 reads out this configuration information from the configuration information file 251, and then, the process operation is advanced to the normal copy mode (step S63). In a case where such configuration information is not present (“NO” in step S62), the CPU 21 reads out the previously stored model information from the model information file 252 (step S64).

Then, the CPU 21 adds a MAC address to a data packet of the read model information, and then transmits the resulting data packet via the communication unit 26 to the computer 1 (step S65). The CPU 11 of the computer 1 receives both the MAC address and the model information (step S66). The CPU 11 determines whether or not the received model information (both model name and version) is made coincident with the model information stored in the configuration information storage file 151 (step S67). In other words, since the configuration information has been stored in the configuration information storage file 151 in a status correlated with the model information, the CPU 11 retrieves such configuration information which is made coincident with the model information so as to retrieve this configuration information.

In a case where the determination result becomes “YES” in the step S67, the CPU 11 reads such configuration information corresponding to the model information made coincident therewith from the configuration information storage file 151 (step S71), and then transmits the read configuration information to the printer 2 (step S72). For instance, in the case that the configuration information of the printer 2A (A11) has already been stored in the configuration information storage file 151, since both the model names and the versions, which are equal to the model information, as to the printer 2A (A12) and the printer 2A (A13) are made coincident with those of this printer 2A (A11), the same configuration information as that of the printer 2A (A11) is transmitted. On the other hand, although the model name of the printer 2A (A24) is identical to the model name of the printer 2A (A11), since the version “2” of this printer 2A (A24) is different from the version “1” of the printer 2A (A11), the configuration information of the printer 2A (A11) is not transmitted. Also, since the model names of the printer 2B, the printer 2C, and the printer 2D are different from the machine name of the printer 2A (A11), the configuration information of this printer 2A (A11) is not transmitted.

In a case where the configuration information is transmitted from the computer 1 to the printer 2, the CPU 21 of the printer 2 stores this transmitted configuration information into the configuration information file 251 of the storage unit 25 (step S73). The CPU 21 determines whether or not the configuring operation is completed, namely determines whether or not the configuration information has been correctly stored in the configuration information file 251 (step S74). In a case where the configuring operation is completed (“YES” in step S74), the CPU 21 transmits such information for indicating that the configuring operation is completed to the computer 1 (step S75). In a case where the configuring operation fails (“NO” in step S74), the CPU 21 transmits such information indicating that the configuring operation fails to the computer 1 (step S76).

Also, when the determination result becomes “NO” in the step S67, namely, in a case where the coincident configuration information is not present, since the initial configuring operation as to this printer 2 has not yet been completed, the CPU 11 of the computer 1 transmits such an information indicating that the configuration information is not present to the printer 2 (step S77). In a case where the CPU 21 of the printer 2 receives such information representing that the configuration information is not present, the present operation mode is advanced to the configuring mode (step S78). Thereafter, the process operation is advanced to the step S33 (refer to FIG. 3). In the step S33, the initial configuring process operation explained in FIG. 3 is carried out. The above-described process operation is carried out every time the printer 2 is connected to the computer 1, so that the configuration information can be reflected in the batch manner as to the same models of printers 2.

### SECOND EMBODIMENT

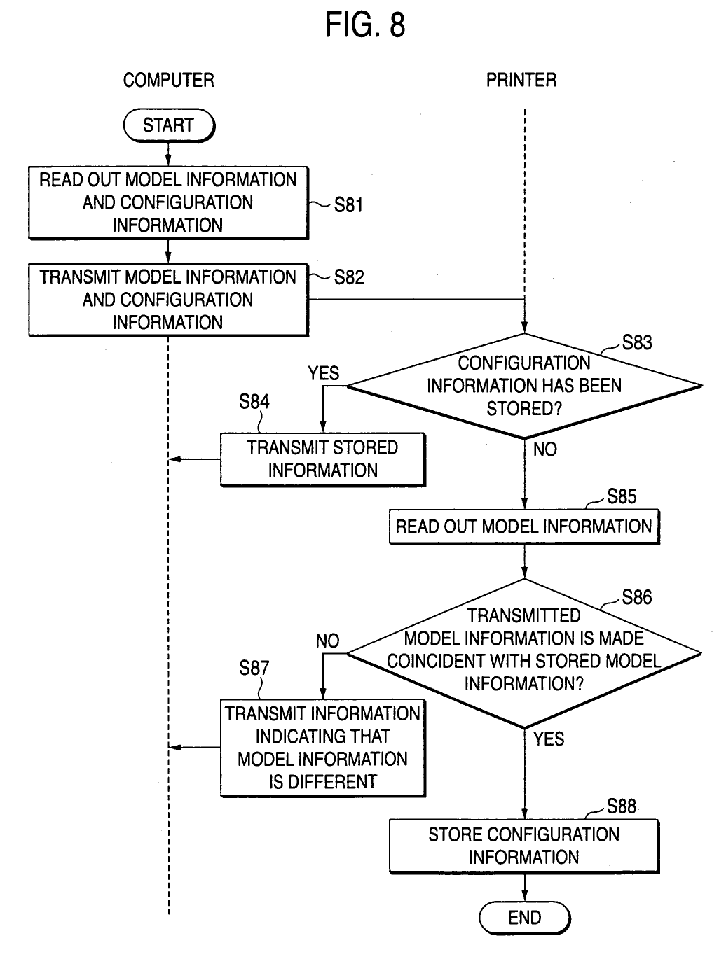

In the first embodiment, the determination that whether or not the transmitted model information is made coincident with the stored model information is carried out by the computer 1. In a second embodiment, such a determination is carried out on the side of the printer 2. FIG. 8 is a flow chart for describing a configuring sequential operation of another printer 2 after an initial configuring operation has been carried out in the second embodiment. First, the CPU 11 of the computer 1 reads out both model information and configuration information, which have been stored in the configuration information storage file 151 by the step S38 (step S81). Subsequently, the CPU 11 sends the read model information and the read configuration information to the respective printers 2 which are connected to the communication network “N” (step S82).

The CPU 21 of the printer 2 which receives both the model information and the configuration information determines whether or not the configuration information has already been stored in the configuration information file 251 (step S83). In such a case that the configuration information has already been stored (“YES” in step S83), since the configuration information need not be again written into the configuration information file 251, the CPU 21 transmits such an information that the configuration information has already been stored to the computer 1 (step S84). On the other hand, in a case where the configuration information has not yet been stored (“NO” is step S83), the CPU 21 reads out model information from the model information file 252 (step S85).

The CPU 21 determines whether or not the read model information is made coincident with the transmitted model information (step S86). When the read model information is made coincident with the transmitted model information (“YES” in step S86), the CPU 21 stores this transmitted configuration information into the configuration information file 251 (step S88). On the other hand, when the read model information is not made coincident with the transmitted model information (“NO” in step S86), since either the model names or the versions are different from each other, the CPU 21 transmits such an information that the model information thereof is different to the computer 1 in combination with a MAC address (step S87). It should also be noted that since process operations defined in steps subsequent to a step S88 are similar to those defined in the steps subsequent to the step S74 shown in FIG. 7, a detailed explanation thereof is omitted.

### THIRD EMBODIMENT

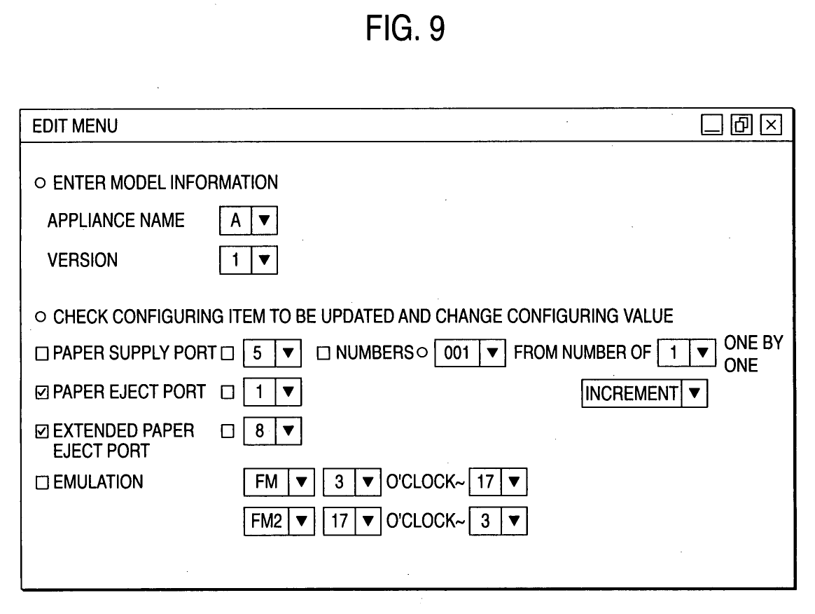

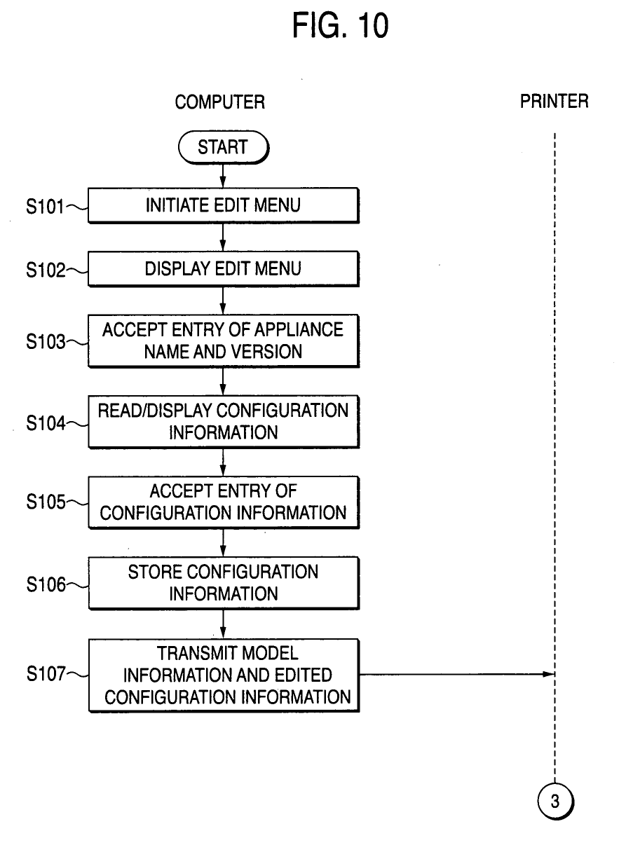

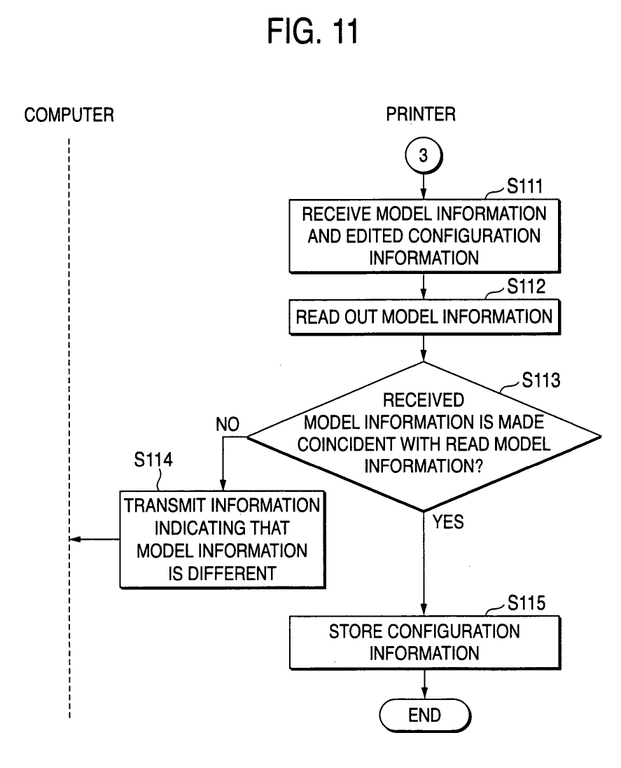

A third embodiment of the present invention is related to a technique capable of editing a configuring condition of a printer 2 which has already been set from the computer 1. FIG. 9 is an explanatory diagram for explanatorily showing an image of an edit menu. FIG. 10 and FIG. 11 are flow charts for explaining a sequential operation of editing process operation. While the editing process operation is carried out, the CPU 11 of the computer 1 executes the control program 15P so as to display such an edit menu as shown in FIG. 9 on the display unit 14.

Both a column for entering model information, and another column for entering a configuring item and a configuring value are displayed in the edit menu. On the edit menu, such a message “enter model information” is firstly displayed, and then, the operator manipulates the input unit 13 so as to enter both an model name and a version, which constitute the model information. In a case where both the model name and the version are entered, the CPU 11 reads out the previously-set information corresponding to the entered model name/version from the configuration information storage file 151, and then displays such a message as represented in FIG. 9. That is, such a message “check configuring condition to be updated, and change configuring value” is displayed on the display unit 14. The operator clicks a configuring item which is required to be edited, and also, changes the configuring value.

As to the configuring item “emulation”, the configuring condition thereof may be changed, depending upon a time range. For example, an emulation “FM” may be set from 3 O'clock until 17 O'clock, and another emulation “FM2” may be set from 17 O'clock up to 3 O'clock. Furthermore, with respect to a configuring item “number”, different numbers may be set when configuration information is transmitted in order to avoid that repeated numbers are applied to the respective printers 2. For example, in such a case that the numbers are set from the number of “001” and are incremented one by one, every time the configuration information is transmitted, the CPU 11 executes such a process operation for incrementing the number of “001” one by one as to the configuring item “number”, so that the number of “001” is set to the first printer 2, the number of “002” is set to the next printer 2, and the number of “003” is set to the further next printer 2.

FIGS. 10 and 11 are flow charts for explaining a sequential operation as to an editing process operation. First, the CPU 11 executes the control program 15P so as to initiate an editing menu (step S101). After the editing menu is initiated, the editing menu is displayed on the display unit 14 (step S103). In a case where the operator enters both an model name and a version from the input unit 13, which correspond to the model information, the CPU 11 retrieves the configuration information storage file 151 in accordance with the model information related to the entered model name and the entered version, and reads outs configuration information from this configuration information storage file 151 to display this read configuration information on the display unit 14 (step 104).

When the configuration information is entered from the input unit 13, the CPU 11 accepts this configuration information (step S105), and then stores the accepted configuration information into the configuration information storage file 151 in a status correlated with the model information (step S106). Also, the CPU 11 transmits both the model information and the edited configuration information which corresponds to the first-mentioned model information to the printer 2 (step S107). It should also be understood that as the configuration information transmitted by the CPU 11, only the changed configuration information maybe alternatively transmitted. In a case where the CPU 21 of the printer 2 receives both the model information and the edited configuration information (step S111), the CPU 21 reads out model information from the model information file 252 (step S112). Then, the CPU 21 determines whether or not the read model information is made coincident with the transmitted model information (step S113). When the read model information is made coincident with the transmitted model information (“YES” in step S113), the CPU 21 stores this transmitted configuration information into the configuration information file 251 (step S115).

On the other hand, when the read model information is not made coincident with the transmitted model information (“NO” in step S113), since either the model names or the versions are different, the CPU 21 transmits such an information indicating that the model information is different to the computer 1 (step S114). Subsequently, in a case where a configuring operation is carried out with respect to another printer 2, the computer 1 executes the configuring operation after the configuring value of the configuring item “number” has been incremented by a value “1”. Also, the computer 1 performs an editing operation by a similar process operation with respect to another printer 2 whose model name is different from the above-described model name, and another printer 2 whose version is different from the above-explained version. With employment of the above-described arrangement, an editing work which has been carried out in one printer 2 can be reflected to all of the same machine sort of printers 2, so that a erroneous operation caused by an operator can be reduced.

### FOURTH EMBODIMENT

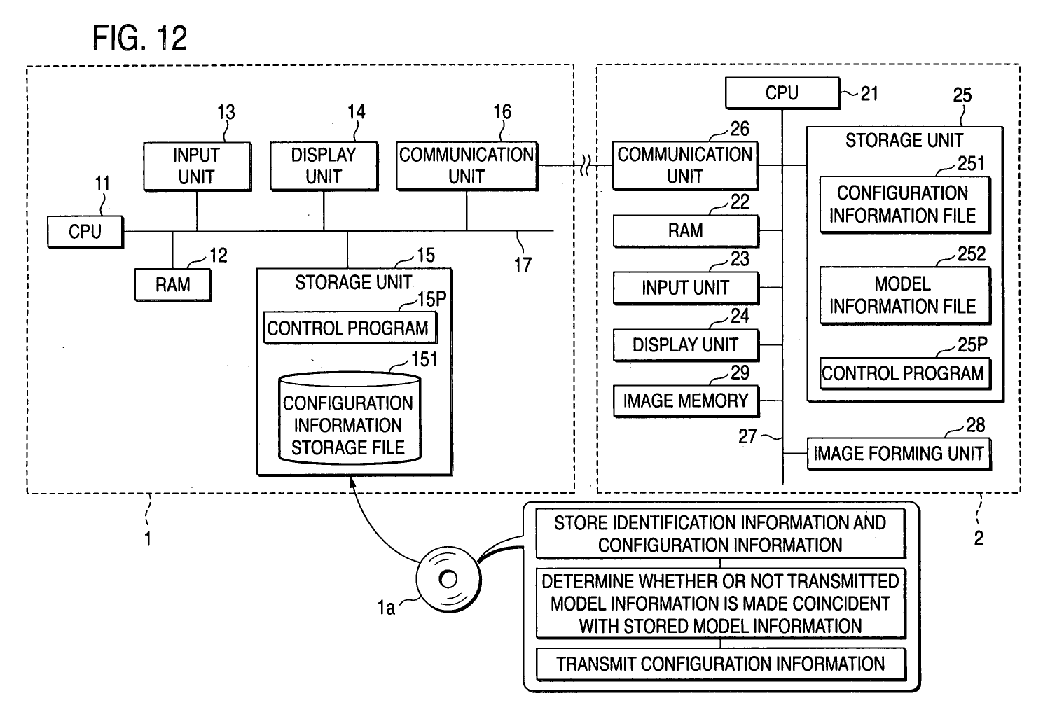

FIG. 12 is a block diagram for indicating an arrangement of a computer 1 according to a fourth embodiment of the present invention. It should be understood that the computer program used to execute the computer 1 according to the first embodiment may be alternatively pre-installed in the computer 1 so as to be provided, or may also be provided in the form of a portable type recording medium such as a CD-ROM and an MO-disk, as realized in the fourth embodiment. Further, the computer program may be alternatively propagated via a line as a carrier wave so as to be provided. Contents of the above-explained embodiment 4 are explained as follows.

A recording medium 1a (CD-ROM, MO-disk, or DVD-ROM) on which a program has been recorded has been pre-installed in a storage unit 15 of the computer 1 shown in FIG. 12, while the program may case the computer 1 to acquire identification information, to acquire configuration information, to determine as to whether or not transmitted model information is made coincident with stored model information, and to transmit configuration information. This program is loaded on a RAM 12 of the computer 1 and is executed. As a result, the program may function as the above-described computer 1 of the present invention.

While the second embodiment through the fourthe embodiment are constructed as explained above, since other arrangements and operations are similar to those of the first embodiment, the same reference numerals are applied to structural units corresponding thereto, and detailed explanations thereof are omitted.

As previously described in detail, the information processing apparatus acquires from the device both the model information and the identification information specific to the device, and also acquires the configuration information of the device. Then, the information processing apparatus stores the acquired configuration information in a status correlated with the model information and the identification information. On the other hand, in such a case that both the model information and the identification information are transmitted from another device, the information processing apparatus determines whether the stored model information is made coincident with the transmitted model information. When the transmitted model information is not made coincident with the stored model information, since the transmitted model information corresponds to another model, the information processing apparatus does not transmit the configuration information. On the other hand, in such a case that the transmitted model information is made coincident with the stored model information, the information processing apparatus transmits such configuration information which has been stored in a status correlated with this model information to the above-described another device. Otherwise, the determination as to whether or not the transmitted model information is made coincident with the stored model information is carried out on the side of the respective devices.

Finally, the above-described another device which has received the configuration information executes the various sorts of configuring operations in accordance with the transmitted configuration information. Since these process operations are carried out with respect to all of the devices which are connected to the communication network, the erroneous operation caused by an operator related to the input work can be avoided. Also, the configuring conditions properly adapted to the respective models can be carried out with respect to all of the devices in a comprehensive manner.

Also, in the present invention, in such a case that the configuring operation of the transmitted configuring operation is completed, another device transmits the completion information indicating that the configuring operation is completed with respect to the information processing apparatus. Since the above-explained arrangement is employed, in the information processing apparatus for managing all of the devices, the information processing apparatus can readily grasp the configuring condition of the respective devices, and when the configuring error happens to occur, the information processing apparatus can easily find out the configuring error.

Furthermore, according to the present invention, while the function capable of editing configuration information of a device is provided with the information processing apparatus, the edited configuration information is transmitted to the same machine sort of the respective devices, and then, the respective devices which have received the edited configuration information carry out the reconfiguring process operation in accordance with this edited configuration information. As a result, even in such a case that the configuring condition is wanted to be slightly changed, the configuring conditions may be rewritten with respect to such devices on which the configuring conditions should be reflected, namely, the present invention may achieve such a superior advantage.

In accordance with the present invention, in order to set the respective devices in a comprehensive manner, the respective devices and the information processing apparatus are connected to each other via the communication network. The information processing apparatus acquires both model information of a device and identification information such as a MAC (Media Access Control) address specific to this device from this device, and also, acquires configuration information of the device. Then, the information processing apparatus stores the acquired configuration information in a status correlated with the model information and the identification information. As a consequence, the configuration information of the device related to one machine sort is firstly stored. On the other hand, in such a case that both the model information and the identification information are transmitted from another device, the information processing apparatus determines whether or not the stored model information is made coincident with the transmitted model information. When the transmitted model information is not made coincident with the stored model information, since the transmitted model information corresponds to another model, the information processing apparatus does not transmit the configuration information. On the other hand, when the transmitted model information is made coincident with the stored model information, the information processing apparatus transmits such configuration information which has been stored in a status correlated with the model information to the above-described another device. Otherwise, the determination as to whether or not the transmitted model information is made coincident with the stored model information is carried out on the side of the respective devices.

The above-described another device which has received the configuration information executes the various sorts of configuring operations in accordance with the transmitted configuration information. Since the process operations are carried out with respect to all of the devices which are connected to the communication network, the erroneous operation caused by an operator related to the input work can be avoided. Also, the configuring operations properly adapted to the respective models can be carried out with respect to all of the devices in a comprehensive manner.

Also, in the present invention, in such a case that the configuring operation of the transmitted configuring operation is completed, another device transmits the completion information indicating that the configuring operation is completed with respect to the information processing apparatus. Since the above-explained arrangement is employed, in the information processing apparatus for managing all of the devices, the information processing apparatus can readily grasp the configuring condition of the respective devices, and when the configuring error happens to occur, the information processing apparatus can easily find out the configuring error.

Furthermore, according to the present invention, while the function capable of editing configuration information of a device is provided with the information processing apparatus, the edited configuration information is transmitted to the same model of the respective devices, and then, the respective devices which have received this edited configuration information carry out the reconfiguring process operation in accordance with the edited configuration information. As a result, even in such a case that the configuring condition is wanted to be slightly changed, the configuring conditions may be rewritten with respect to such devices on which the configuring conditions should be reflected.

Although the present invention has been shown and described with reference to specific preferred embodiments, various changes and modifications will be apparent to those skilled in the art from the teachings herein. Such changes and modifications as are obvious are deemed to come within the spirit, scope and contemplation of the invention as defined in the appended claims.

What is claimed is:

1. A device configuring method for configuring a plurality of devices of various kinds by an information processing apparatus in which connected to the devices via a communication network, the method comprising:
acquiring from a first device both model information of the first device and identification information specific to the first device by the information processing apparatus;
acquiring from the first device configuration information of the first device by the information processing apparatus;
storing the acquired configuration information in a status correlated with both the model information and the identification information of the first device;
acquiring from a second device both model information of the second device and identification information specific to the second device by the information processing apparatus;
determining whether or not the model information of the first device and the model information of the second device coincide with each other;
transmitting, when determined that the model information of the first device and the model information of the second device coincide with each other, the stored configuration information of the first device from the information processing apparatus to the second device; and
configuring the second device in accordance with the transmitted configuration information.

2. A device configuring system comprising:
a plurality of devices of various kinds; and
an information processing apparatus in which connected to the devices via a communication network,
wherein the information processing apparatus comprises:
a first acquiring unit configured to acquire from a first device both model information of the first device and identification information specific to the first device;
a configuration information acquiring unit configured to acquire from the first device configuration information of the first device;
a storing unit configured to store the acquired configuration information in a status correlated with both the model information and the identification information of the first device;
a second acquiring unit configured to acquire from a second device both model information of the second device and identification information specific to the second device;
a determining unit configured to determine whether or not the model information of the first device and the model information of the second device coincide with each other; and
a transmitting unit configured to transmit, when determined that the model information of the first device and the model information of the second device coincide with each other, the stored configuration information of the first device to the second device,
wherein the second device comprises a configuring unit configured to perform a configuration thereof in accordance with the transmitted configuration information.

3. The device configuring system as claimed in claim 2, wherein the second device further comprises a completion information transmitting unit configured to transmit, after the configuration is completed, completion information that indicates the completion of the configuration to the information processing apparatus.

4. The device configuring system as claimed in claim 2, wherein the information processing apparatus further comprises an editing unit configured to edit the configuration information,
wherein the storing unit is further configured to store the edited configuration information, and
wherein the transmitting unit is configured to transmit the edited configuration information as the configuration information to the second device.

5. The device configuring system as claimed in claim 2, wherein the identification comprises an MAC address of the device.

6. A device configuring system comprising:
a plurality of devices of various kinds; and
an information processing apparatus in which connected to the devices via a communication network,
wherein the information processing apparatus comprises:
a first acquiring unit configured to acquire from a first device model information of the first device;
a configuration information acquiring unit configured to acquire from the first device configuration information of the first device;
a storing unit configured to store the acquired configuration information in a status correlated with the model information of the first device; and
a transmitting unit configured to transmit the stored configuration information of the first device together with the correlated model information to a second device,
wherein the second device comprises:
a determining unit configured to determine whether or not the transmitted model information of the first device coincides with a previously stored model information thereof; and
a configuring unit configured to perform a configuration thereof in accordance with the transmitted configuration information in a case where determined that the transmitted model information and the previously stored model information coincide each other.

7. An information processing apparatus for configuring a plurality of devices of various kinds that are connected thereto via a communication network, the apparatus comprising:
a first acquiring unit configured to acquire from a first device both model information of the first device and identification information specific to the first device;
a configuration information acquiring unit configured to acquire from the first device configuration information of the first device;
a storing unit configured to store the acquired configuration information in a status correlated with both the model information and the identification information of the first device;
a second acquiring unit configured to acquire from a second device both model information of the second device and identification information specific to the second device;
a determining unit configured to determine whether or not the model information of the first device and the model information of the second device coincide with each other; and
a transmitting unit configured to transmit, when determined that the model information of the first device and the model information of the second device coincide with each other, the stored configuration information of the first device to the second device.

8. A software program product for causing a computer system to execute procedures for configuring a plurality of devices of various kinds that are connected thereto via a communication network, the software program product comprising:
means for acquiring, from a first device, model information of the first device, identification information specific to the first device, and configuration information of the first device;
means for storing the acquired configuration information in a status correlated with both the model information and the identification information of the first device;
means for acquiring from a second device both model information of the second device and identification information specific to the second device;
means for determining whether or not the model information of the first device and the model information of the second device coincide with each other; and
means for transmitting, when determined that the model information of the first device and the model information of the second device coincide with each other, the stored configuration information of the first device to the second device.
